(19) United States
(12) Patent Application Publication
(10) Pub. No.: US 2017/0279976 A1
(43) Pub. Date: Sep. 28, 2017

(54) ANTITHEFT APPARATUS AND IMAGE FORMING APPARATUS

(71) Applicant: FUJI XEROX CO., LTD., Tokyo (JP)

(72) Inventors: Manabu HAYASHI, Yokohama-shi (JP); Masafumi ONO, Yokohama-shi (JP); Naoya NOBUTANI, Yokohama-shi (JP); Toru SUZUKI, Yokohama-shi (JP); Kunitoshi YAMAMOTO, Yokohama-shi (JP)

(73) Assignee: FUJI XEROX CO., LTD., Tokyo (JP)

(21) Appl. No.: 15/218,471

(22) Filed: Jul. 25, 2016

(30) Foreign Application Priority Data
Mar. 28, 2016 (JP) 2016-063084

(51) Int. Cl. H04N 1/00

(52) U.S. Cl. CPC H04N 1/00037; H04N 1/00251; H04N 1/00015; H04N 1/00058; H04N 1/00074; H04N 2201/0094

(57) ABSTRACT

There is provided an antitheft apparatus. An approach detector is disposed on an apparatus where consumables are mounted, and detects a person who approaches the corresponding apparatus. An image acquisition unit acquires a captured image of the person when the person's approaching is detected by the approach detector. A detector detects that the consumables are stolen from the apparatus. A recording unit, when the stealing is detected by the detector, matches an image which is captured by a capturing apparatus at a most recent time before the detecting, with information of the detection, and records the image and the information.

### CROSS-REFERENCE TO RELATED APPLICATIONS

This application is based on and claims priority under 35 U.S.C. §119 from Japanese Patent Application No. 2016-063084 filed on Mar. 28, 2016.

### TECHNICAL FIELD

The present invention relates to an antitheft apparatus and an image forming apparatus.

### SUMMARY

According to an aspect of the embodiments of the present invention, there is provided to an antitheft apparatus comprising: an approach detector that is disposed on an apparatus where consumables are mounted, and detects a person who approaches the corresponding apparatus; an image acquisition unit that acquires a captured image of the person when the person's approaching is detected by the approach detector; a detector that detects that the consumables are stolen from the apparatus; and a recording unit that, when the stealing is detected by the detector, matches an image which is captured by a capturing apparatus at a most recent time before the detecting, with information of the detecting, and records the image and the information.

### BRIEF DESCRIPTION OF THE DRAWINGS

Exemplary embodiments of the present invention will be described in detailed based on the following figures, wherein:

FIG. 1 is a view illustrating an exterior of a multifunction device which has an exemplary embodiment of an antitheft apparatus of the invention mounted therein, and which corresponds to an exemplary embodiment of an image forming apparatus of the invention;

FIG. 2 is a configuration diagram conceptually illustrating a hardware configuration of the multifunction device illustrated in FIG. 1;

FIG. 3 is a view illustrating an instance of a configuration of an image forming unit;

FIG. 4 is a function block diagram illustrating a functional configuration as an exemplary embodiment of an antitheft apparatus of the invention;

FIG. 5 is a flowchart illustrating an operation sequence of the antitheft apparatus in a typical process of the multifunction device;

FIG. 6 is a flowchart illustrating an operation sequence of the antitheft apparatus in a consumable replacement process: and

FIG. 7 is a flowchart illustrating an operation sequence of the antitheft apparatus in a power-on process.

### DETAILED DESCRIPTION

Exemplary embodiments of the present invention will he described with reference to the accompanying drawings.

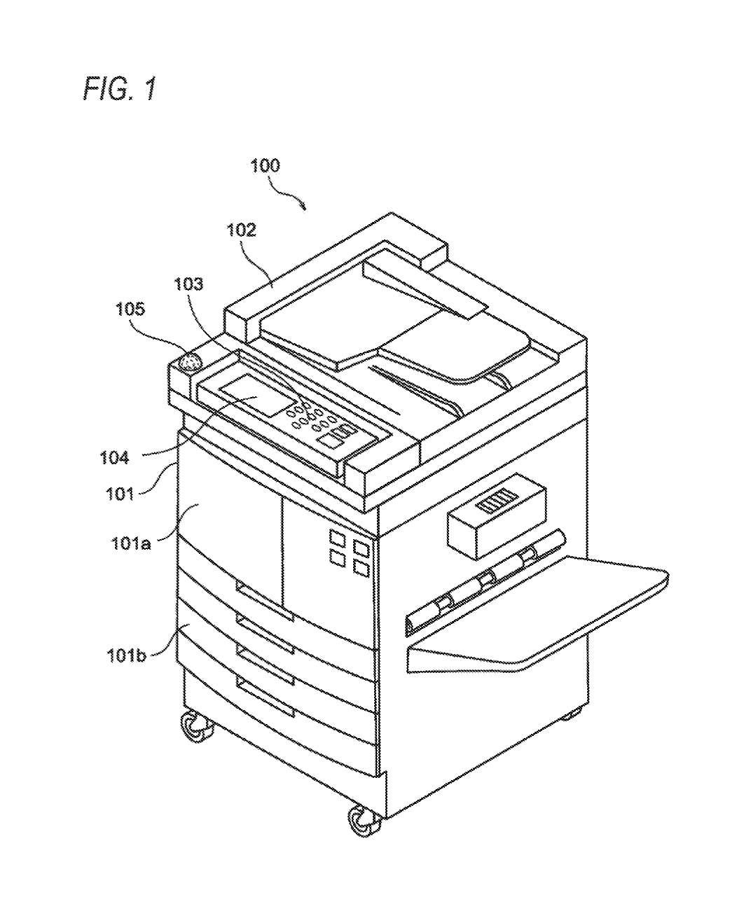

FIG. 1 is a view illustrating an exterior of a multifunction device which has an exemplary embodiment of an antitheft apparatus of the invention mounted therein, and which corresponds to an exemplary embodiment of an image forming apparatus of the invention.

A multifunction device 100 illustrated in FIG. 1 has functions as a printer, a copier, a scanner, and a facsimile.

The multifunction device 100 has a structure in which a reading unit 102 is placed on the upper portion of a body portion 101 in appearance. The reading unit 102 reads an image of an original document.

In addition, an operation unit 103 and a display 104 are disposed on the front surface side of the upper portion of the multifunction device 100, and the user of the multifunction device 100 stands hieing the front surface side of the multifunction device 100 and operates the operation unit 103.

The operation unit 103 is operated by the user to instruct the multifunction device 100 to perform an operation, and the display 104 displays an operation state of the multifunction device 100 or an operation content for the multifunction device 100.

An opening and closing cover 101a and a sheet tray 101b are provided on the front surface side of the body portion 101, and the opening and closing cover 10 la is opened by the user when a toner cartridge are replaced or there is a paper jam. The sheet: tray 101b is withdrawn from the body portion 101 by the user when the sheet tray 101b is replenished with sheets.

An exemplary embodiment of the antitheft apparatus of the invention is mounted in the multifunction device 100, and a capturing unit (camera) 105 is also provided in the multifunction device 100 to obtain an image identifying a thief by capturing.

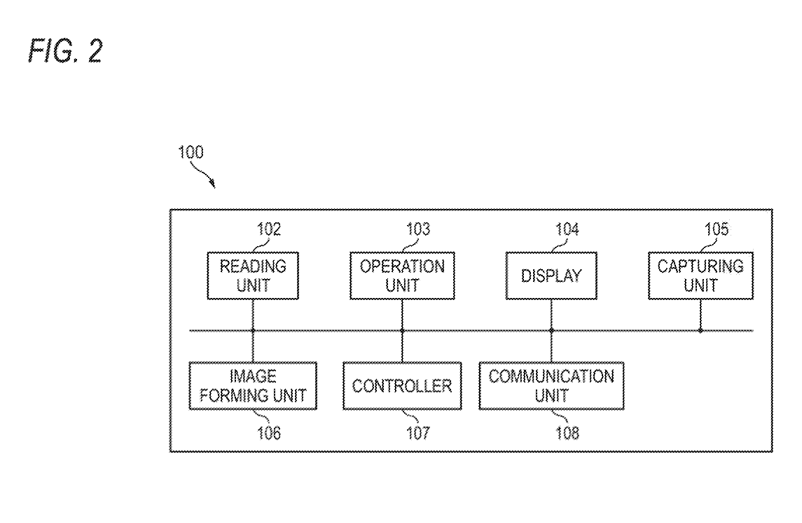

FIG. 2 is a configuration diagram conceptually illustrating a hardware configuration of the multifunction device 100 illustrated in FIG. 1.

The multifunction device 100 includes the reading unit 102, the operation unit 103, the display 104 and the capturing unit 105 as illustrated in FIG. 1, and also, includes an image forming unit 106, a controller 107, and a communication unit 108 in the above-described body portion 101,

For instance, the image forming unit 106 forms an image on the sheet in an electrophotographic system and corresponds to an instance of an image forming unit mentioned in the invention. The image forming unit 106 will be described in detail below.

The communication unit 108 performs a function of obtaining image data for printing from an external device such as a personal computer, or a function of transmitting the internal state of the multifunction device 100 to the manager of the multifunction device 100.

The controller 107 is responsible for controlling the overall operation of the multifunction device 100, and for instance, is a so-called board computer which is provided with an operation element such as a CPU, a memory such as a ROM, or a timer. In recent years, control functions are distributed on respective locations within the multifunction device 100 as a Micro Controller Unit (MCU). However, for convenience of explanation, the control functions recited herein are regarded as being concentrated in the single controller 107.

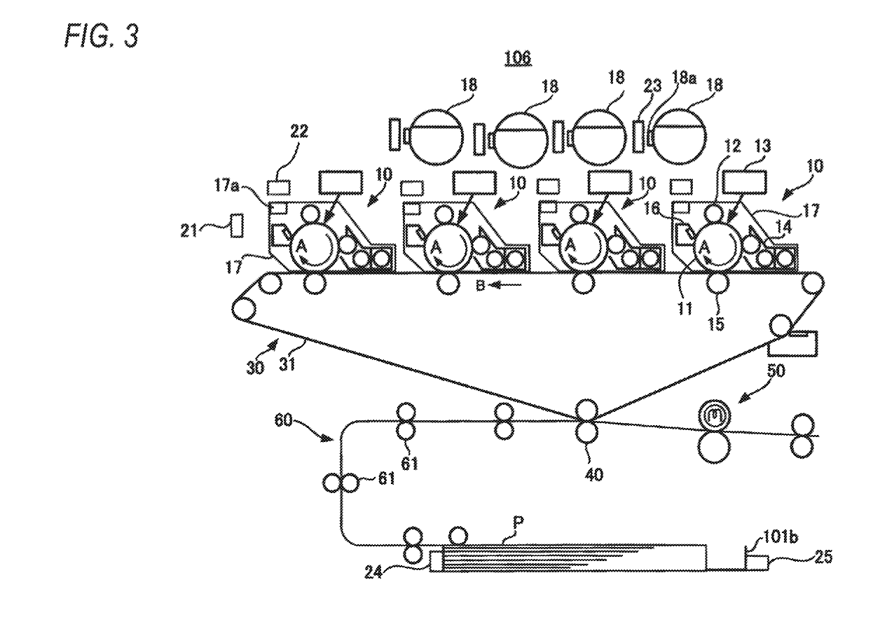

FIG. 3 is a view illustrating an instance of a configuration of the image forming unit 106,

The image forming unit 106 illustrated in FIG. 3 is a tandem type electrophotographic apparatus which has four image engines 10 arranged in parallel and corresponding to colors of YMCK, and is able to print a full color image which is formed of four color toner images, in addition to printing a single color image.

Each of the image engines 10 includes a photoconductor drum 11, a charging device 12, an exposure device 13, a developing, device 14, a primary transfer device 15, and a photoconductor cleaner 16. The photoconductor drum 11, the charging device 12, the developing device 14, and the photoconductor cleaner 16 from among the elements included in the image engine 10 are integrated into a drum cartridge 17 which is detachably mounted in the image forming unit 106. The drum cartridge 17 is attached to or detached from the image forming unit 106 through an opening which opens the opening and closing cover 101a illustrated in FIG. 1. The image forming unit 106 has a cover switch 21 formed therein to detect opening and closing of the opening and closing cover 101a. The cover switch 21 is a mechanical switch and the controller 107 illustrated in FIG. 2 determines the opening and closing ate of the opening and closing cover 101a by determining the state of the cover switch 21.

The photoconductor drum 11 of the image engine 10 is a drum which has a photoconductive layer formed on a surface thereof, and is rotated in the direction of arrow A while holding an image formed on the surface. The charging device 12, the exposure device 13, the developing device 14, the primary transfer device 15, and the photoconductor cleaner 16 are arranged on the periphery of the photoconductor drum 11 in order of the direction of arrow A.

The charging device 12 is a device which charges the surface of the photoconductor drum 11. The exposure device 13 forms an electrostatic latent image on the surface of the photoconductor drum 11 by irradiating the photoconductor drum 11 with light corresponding to an image signal. The developing device 14 develops the surface of the photoconductor drum 11 using developer including a toner. The primary transfer device 15 transfers a toner image formed on the photoconductor drum 11 onto an intermediate transfer belt 31. The photoconductor cleaner 16 cleans the surface of the photoconductor drum 11.

Plural (four in this exemplary embodiment) toner cartridges 18 corresponding to the respective image engines 10 are detachably mounted in the image forming unit 106, and toners of respective colors of YMCK are accommodated in the respective toner cartridges 18. The toner is supplied to the developing device 14 from the corresponding toner cartridge 18. The toner cartridge 18 is also attached to or detached from the image forming'unit 106 through the opening which opens the opening and closing cover 101a illustrated in FIG. 1.

The above-described drum cartridge 17 is replaced when the photoconductor drum 11 deteriorates as the drum cartridge 17 is used, and corresponds to an instance of consumables mentioned in the invention, addition, the place where the drum cartridge 17 is mounted within the image forming unit 106 corresponds to an instance of a consumables mounting portion mentioned in the invention.

A memory 17a on which drum information including; time of use of the photoconductor drum 11 is recorded is provided in the drum cartridge 17, and a drum information communication device 22 that wirelessly communicates with the memory 17a and reads and writes the drum information is provided in the image forming unit 106. The controller 107 illustrated in FIG. 2 reads and writes the drum information with respect to the drum cartridge 17 through the drum information communication device 22, and also detects extraction of the drum cartridge 17.

The toner cartridge 18 is replaced when the toner is consumed as the toner cartridge 18 is used, and corresponds to an instance of the consumables mentioned in the invention. The place where the toner cartridge 18 is mounted within the image forming unit 106 corresponds to an instance of the consumables mounting' portion mentioned in the invention.

A memory 18a on which toner information including an amount of remaining toner is recorded is provided on the toner cartridge 18, and a toner information communication device 23 that wirelessly communicates with the memory 18a and reads and writes the toner information is provided in the image forming unit 106. The controller 107 illustrated in FIG. 2 reads and writes the toner information with respect to the toner cartridge 18 through the toner information communication device 23, and also detects extraction of the toner cartridge 18.

The image forming unit 106 further includes a transfer unit 30, a secondary transfer device 40, a fixing device 50, and a sheet transport unit 60. The transfer unit 30 includes the intermediate transfer heft 31, and the intermediate transfer belt 31 circularly moves in the direction of arrow B via the image engines 10 and the secondary' transfer device 40. The toner image is transferred from each of the image engines 10 to the intermediate transfer belt 31, and the intermediate transfer belt 31 holds the toner image and transports the toner image to the secondary transfer device 40.

The sheet transport unit 60 picks up a sheet P accommodated in the sheet tray 101b, and transports the sheet P via the secondary transfer device 40 and the fixing device 50 using a transport roller 61.

The toner image on the intermediate transfer belt 31 and the sheet P overlap each other on the secondary transfer belt 40, and the toner image is transferred onto the sheet P by applying a voltage.

The fixing device 50 fixes the toner image onto the sheet P by heating and pressing the toner image.

The sheet P accommodated in the sheet tray 101b corresponds to an instance of recording material mentioned in the invention, and also, is consumed as the image forming unit 106 is driven, and thus corresponds to an instance of the consumables mentioned in the invention. The image forming unit 106 includes a remaining sheet detector 24 to detect an amount of remaining sheet P accommodated in the sheet tray 101b, and a tray switch 25 to detect withdrawal of the sheet tray 101b. The remaining sheet detector 24 detects the amount of remaining sheet based on the height to which the sheet P in the sheet tray 101b is raised to be picked up by the sheet transport unit 60, and the tray switch 25 is a mechanical switch. The controller 107 illustrated in FIG. 2 acquires the amount of remaining sheet detected by the remaining sheet detector 24, and also, detects the withdrawal of the sheet tray 101b by identifying the state of the tray switch 25. The remaining sheet detector 24 corresponds to an instance of a removal detector mentioned in the invention.

Next., the function of the antitheft apparatus introduced in the multifunction device 100 illustrated in FIGS. 1 and 2 will be described.

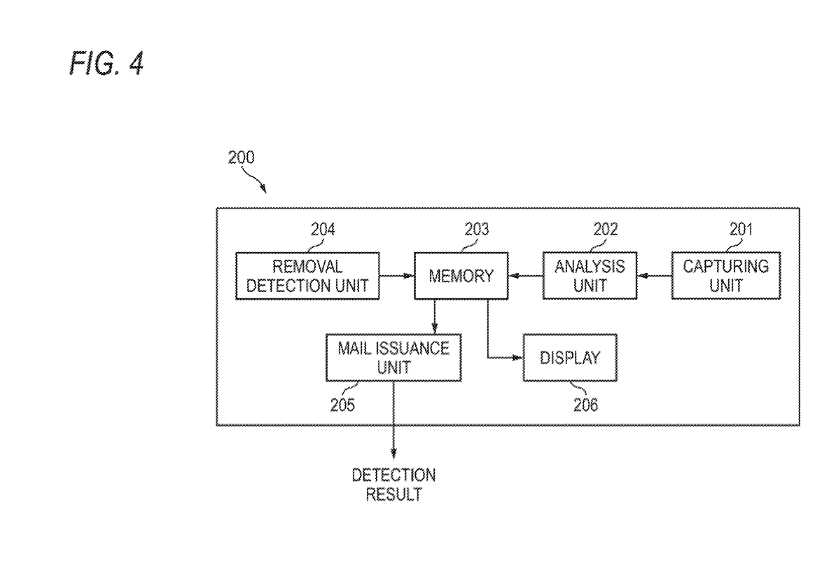

FIG. 4 is a function block diagram illustrating a functional configuration as an 2.0 exemplary embodiment of the antitheft apparatus of the invention.

The antitheft apparatus 200 which is a function includes a capturing unit 201, an analysis unit 202, a memory 203, a removal detection unit 204, a mail issuance unit 205, and a display 206. The roles of the capturing unit 201 and the display 206 in the antitheft apparatus 200 are taken by the capturing unit 105 and the display 104 illustrated in FIGS. 1 and 2, respectively, as hardware. In addition, the roles of the analysis unit 202 and the memory 203 in the antitheft apparatus 200 are taken by the controller 107 illustrated in FIG. 2 as hardware. The role of the removal detection unit 204 in the antitheft apparatus 200 is taken by a combination of the controller 107 illustrated in FIG. 2 and the drum information communication device 22 or the remaining sheet detector 24 described in FIG. 3, as hardware. The role of the mail issuance unit 205 in the antitheft apparatus 200 is taken by a combination of the controller 107 and the communication unit 108 illustrated in FIG. 2 as hardware.

The capturing unit 201 captures an image of the periphery of the multifunction device 100 which is a capturing range at all time. By capturing in this way, regarding the user of the multifunction device 100, the capturing unit 201 may obtain an image indicating the user approaching or a face image after the user approaches. The capturing unit 201 corresponds to an instance of an image acquisition unit mentioned in the invention.

The analysis unit 202 detects a person or a face by analyzing the image obtained by capturing by the capturing unit 201. Regarding an analysis method, a well-known certain analysis method may be employed, and thus a detailed description thereof is omitted herein. However, herein, a person approaching the multifunction device 100 and a stay after the user approaches the periphery of the multifunction device 100 are distinguished from each other and are detected. The analysis unit 202 corresponds to an instance of an approach detector mentioned in the invention.

The removal detection unit 204 detects the theft of the consumables through the drum information communication device 22, the remaining sheet detector 24, or the like described in FIG. 3, and generates detection information including detection time or the like. In addition, regarding the detection of the theft, the removal detection unit 204 may identify opening or closing through the cover switch 21 or the tray switch 25 described in FIG. 3. The removal detection unit 204 corresponds to an instance of the removal detector mentioned in the invention.

The memory 203 has a function of temporarily storing the image which is obtained by capturing by the capturing unit 201, and a function of holding, the image with the detection information generated in the removal detection unit 204. In this exemplary embodiment, the memory 203 may store the above-described drum information or toner information, and also stores the amount of remaining sheet in the sheet tray 101b. The memory 203 corresponds to an instance of a recording unit mentioned in the invention. The memory 203 has a so-called non-volatile memory and holds stored contents even when the power of the multifunction device 100 is turned off.

The mail issuance unit 205 creates an electronic mail to send the detection information and the image to the manager of the multifunction device 100 every time the detection information is stored in the memory 203, and transmits the electronic mail.

The display 206 warns and displays a list of the detection information stored in the memory 203 without waiting for manager's instructions when the manager accesses the multifunction device 100. In addition, regarding an image matching the detection information set forth in the list, the display 206 displays according to manager's instructions.

The mail issuance unit 205 corresponds to an instance of a notification unit mentioned in the invention, and the display 206 corresponds to another instance of the notification unit mentioned in the invention.

Hereinafter, the operation of the antitheft apparatus 200 will be described with reference to a flowchart. In addition, FIGS. 1 to 4 will be referred to by illustrating signs without mentioning drawing numbers prior to explaining the flowchart.

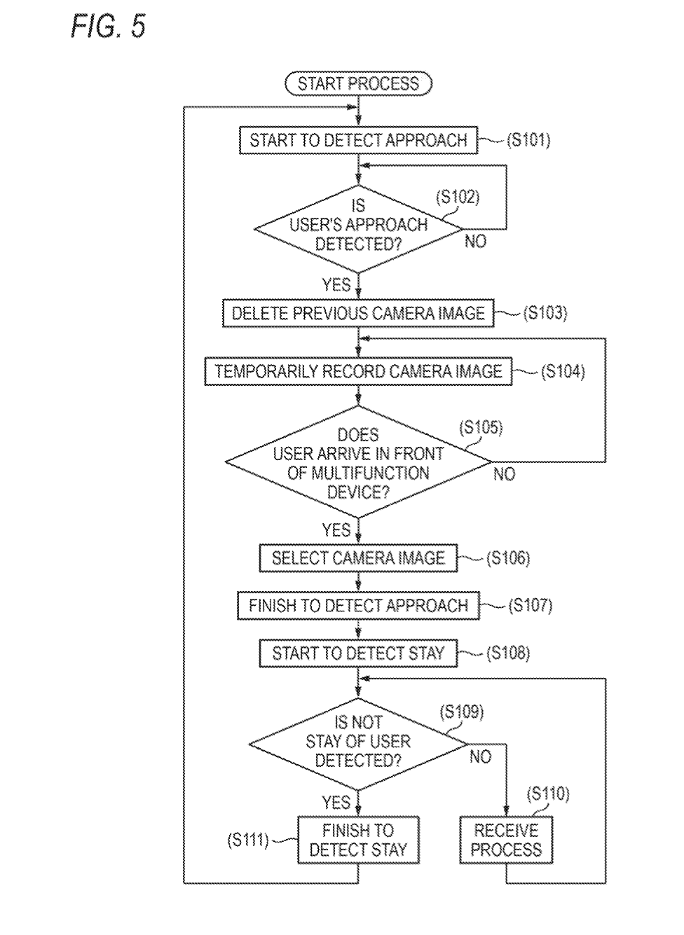

FIG. 5 is a flowchart illustrating an operation sequence of the antitheft apparatus 200 in a typical process of the multifunction device 100.

The operation of the typical process illustrated in the flowchart of FIG. 5 starts When a processing operation when power is turned on, which will be described below, terminates,

When the operation of the typical process starts, the capturing unit 201 and the analysis unit 202 start detecting a person (user) approaching the multifunction device 100 (step S101), and stand by until the approach is detected (step S102; N).

When the user's approaching the multifunction device 100 is detected (step S102: Y), an image which is obtained by previous capturing and temporarily stored in the memory 203 is deleted (step S103), and an image which is obtained by present capturing is temporarily stored in the memory 203 (step S104). The capturing of the user and the storing of the image continue until the user arrives in front of the multifunction device 100 (step S105, N).

When the user arrives in front of the multifunction device 100 (step S105: Y), an image from which a user's face is identified as being large and clearly identified is selected from the images temporarily stored in the memory 203 (step S106). The detecting the approach terminates (step S107), and detecting the stay of the user in the periphery of the multifunction device 100 starts (step S108),

Thereafter, the multifunction device 100 receives a copying process or a printing process which is instructed by the user and executes the copying process or printing process (step S110) while the user is staying in the periphery of the multifunction device 100 (step S109; N). In this case, the sheet or toner is consumed as the image forming unit 106 is driven and the deterioration of the photoconductor drum slowly progresses. For this reason, the drum information, the toner information, or the amount of remaining sheet stored in the memory 203 is appropriately updated. In addition, the process received in step S110 includes a process of turning off the power of the multifunction device 100, and, when the process of turning off the power is executed, the operation of the typical process terminates regardless of the flow of the flowchart illustrated in Fie, 5.

When the stay of the user in the periphery of the multifunction device 100 is not detected in step S109 (step S109, Y), the detecting the stay of the user terminates (step S111), and the operation in step S101 resumes and the above-described respective steps are repeated.

Next, a consumables replacement process which is executed by the antitheft apparatus 200 when the user replaces the consumables of the multifunction device 100 will be described.

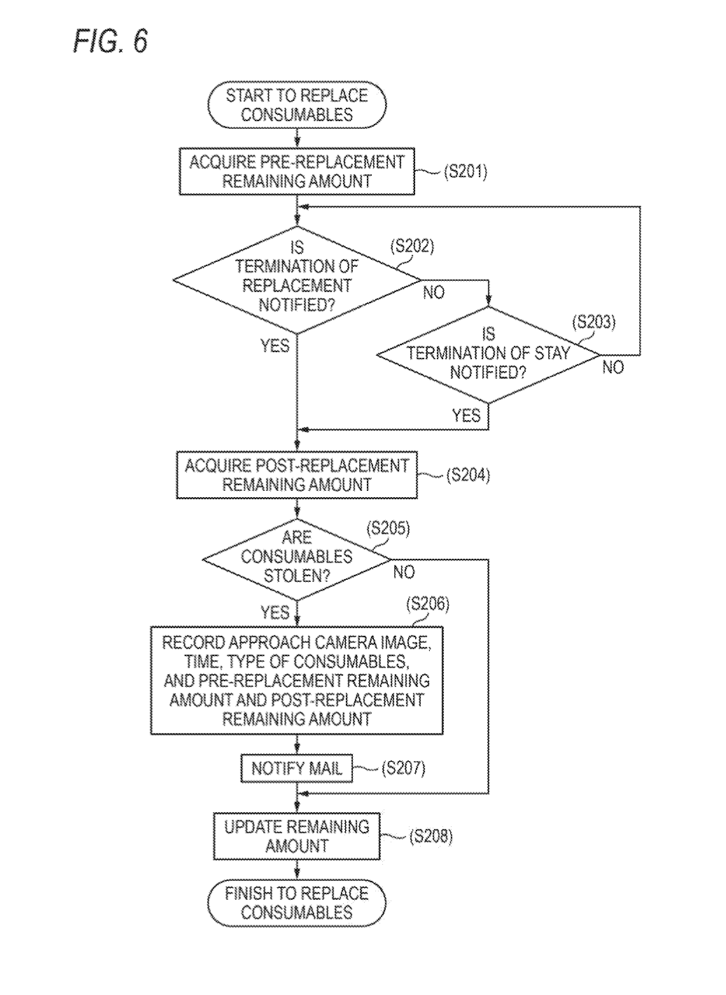

FIG. 6 is a flowchart illustrating an operation sequence of the antitheft apparatus in the consumables replacement process.

The operation of the consumables replacement process starts when one of the opening of the opening and closing, cover 101a and the withdrawal of the sheet tray 101b is detected. In addition, it is, deemed that, when the operation of the consumables replacement process starts, the detecting the stay of the user disclosed in step S108 of FIG. 5 continues.

When the consumables replacement process starts, the drum information, the toner information, or the amount of remaining sheet, which is stored in the memory 203, is read out by the removal detection unit 204 as “pre-replace merit remaining amount” before the opening of the opening and closing cover 101a or the withdrawal of the sheet tray 101b is detected (step S201). Thereafter, the antitheft apparatus 200 is in a standby state when the closing of the opening and closing cover 101a or the pushing back of the sheet tray 101b indicating that the consumables are completely replaced or replenished is not detected (step S202; No), and when the user is staying (step S203; No).

When the closing of the opening and dosing cover 101a or the pushing hack of the to sheet tray 101b indicating that the consumables are completely replaced or replenished is detected (step S202; Yes), or when the termination of the stay of the user is detected (step S203; Yes), the removal detection unit 204 acquires current drum information and toner information through the drum information communication device 22 and the toner information communication device 23 and acquires a current amount of remaining sheet detected by the remaining sheet detector 24, as “post-replacement remaining amount” (step S204).

When the “post-replacement remaining amount” is reduced by more than a predetermined threshold value in comparison to the “pre-replacement remaining amount”, or at least one of the drum information communication device 22 and the toner information communication device 23 is detected as being extracted from at least one of the toner cartridge 18 and the drum cartridge 7, the removal detection unit 204 determines that the consumables are stolen (step S205; Yes).

The removal detection unit 204 matches a recent person image, a current time, and a type of stolen consumables, which are temporarily stored in the memory 203, with the “pre-replacement remaining amount” and the “post-replacement remaining amount”, and stores in the memory 203 as a preservation record (step S206). Herein, a combination of the current time and the type of the consumables and the “pre-replacement remaining amount” and the “post-replacement remaining amounts” is the above-described detection information. Since the person image matching the detection information is the image which is photographed when the person (user) approaches the multifunction device 100, it is expected that a valid face is well photographed to identify the person, and a thief can be clearly identified in comparison to a case in which a person is captured in association with the removal of the consumables.

When the person image and the detection information match each other and are recorded on the memory 203 as described above, an electronic mail including the detection information and the person image is generated by the, mail issuance unit 205 and transmitted to the manager (step 8207). The electronic mail is immediately issued when the consumables are carried out, and thus the immediacy is enhanced.

After the electronic mail is transmitted, the drum information, the toner information, or the amount of remaining sheet stored in the memory 203 is updated with current information or a current amount of remaining sheet (step S208), and the consumable replacement process terminates.

In addition, when it is determined that the consumables are not stolen in step S205 (step 205; No), the person image or the detection information is not recorded, and the drum information, the toner information, or the amount of remaining sheet is updated (step S208) and the consumable replacement process terminates,

When it is determined that the consumables are stolen in step S205, but the remaining to amount is restored within a predetermined time, it may be thought that the user simply goes to take products for replacing or replenishing. Therefore, the detection information may be deleted from the preservation record of the memory 203, or information indicating low importance may be given. In addition, information indicating importance according to an amount or price of stolen consumables may be given to the preservation record.

Next, a power-on process which is executed before power is supplied to the multifunction device 100 will be described.

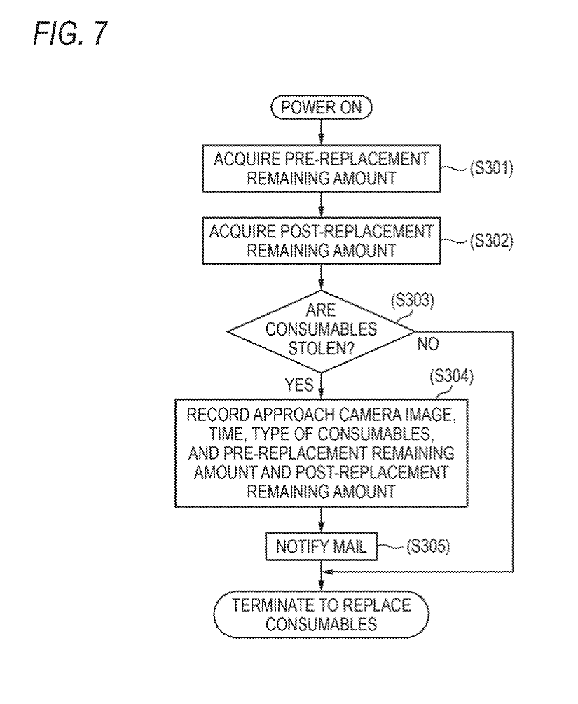

FIG. 7 is a flowchart illustrating an operation sequence of the antitheft apparatus in the power-on process.

The power-on process starts when power is supplied to the multifunction device 100, and the drum information, the toner information, or the amount of remaining sheet which are stored, in the memory 203 is read out by the removal detection unit 204 as “pre-replacement remaining amount”(step S301). Next, the removal detection unit 204 acquires current drum information and toner information through the drum information communication device 22 and the toner information communication device 23, and acquires a current amount of remaining sheet which is detected by the remaining sheet detector 24, as “post-replacement remaining amount” (step S302).

When the “post-replacement remaining amount” is reduced by more than a predetermined threshold value in comparison to the “pre-replacement remaining amount”, or when at least one of the drum information communication device 22 and the toner information communication device 23 is detected as being extracted from at least one of the toner cartridge 18 and the drum cartridge 17, the removal detection unit 204 determines that the consumables are stolen while power is shut off (step S303; Yes).

The removal detection unit 204 matches a recent person image which is temporarily stored in the memory 203 and the above-described detection information, and stores in the memory 203 as a preservation record (step S304). In this case, the person image is an image of a user who turns off the power of the multifunction device 100, and it is likely that the person (user) photographed in the person image is a thief who carries out the consumables. The person image may not he obtained by capturing in association with the removal of the consumables, and the thief is clearly identified.

When the person image and the detection information matches each other and are recorded on the memory 203 as described above, an electronic mail including the detection information and the person image is generated by the mail issuance unit 205 and transmitted to the manager (step S305), and the power-on process terminates.

When it is determined that the consumables are not stolen in step S304 (step S304; No), the power-on process directly terminates.

According to the antitheft apparatus of the invention as described above, the thief is clearly identified in comparison to a case in which a person is captured in association with the removal of the consumables.

In the above-described exemplary embodiment, the single capturing unit (camera) detects the approach and captures the person by way of an instance. However, the approach detector and the capturing apparatus mentioned in the invention may be split into plural cameras, and a unit other than the camera, such as a pyroelectric sensor, may be used as the approach detector.

In the above-described exemplary embodiment, a captured image is acquired by the capturing unit provided in the antitheft apparatus, as an instance of an image acquisition unit mentioned in the invention. However, the image acquisition unit mentioned in the invention may acquire an image from a device other than the antitheft apparatus, for instance, a monitoring camera. In the above-described modification example, when the person's approaching is detected by the approach detector mentioned in the invention, the image acquisition unit requests the image when the person approaches from the monitoring camera or network camera which captures the periphery of its own apparatus having the antitheft apparatus mounted therein, and acquires the image. When it is detected that the consumables are stolen, the acquired image and the theft detection match each other and are preserved. In the above-described modification example, it is expected that a blind spot when the periphery of the own apparatus is captured is small in comparison to a case in which an image is acquired by the capturing apparatus mounted in the own apparatus, and the person approaching is more clearly captured.

In the above-described exemplary embodiment, a notification is sent through the electronic mail or the display screen as an instance of the notification unit mentioned in the invention. However, the notification method of the notification unit mentioned in the invention may be a notification which has excellent immediacy due to the electronic mail, a notification which has excellent storage stability of a record by outputting a report in which detection information is printed on sheet, or a notification which is easy of identification through a screen display. In addition, the notification unit mentioned in the invention is not essential, and the antitheft apparatus of the invention has excellent security, so that the manager can access the record and acquire the detection information or the person image.

In the above-described exemplary embodiment, the antitheft apparatus of the invention is introduced in the image forming apparatus by way of an instance. However, the antitheft apparatus of the invention may be introduced in an apparatus other than the image forming apparatus.

In the above-described exemplary embodiment, the so-called tandem method provided with plural image holding members is described. However, the image forming apparatus of the to invention may be a so-called revolver type image forming apparatus which forms toner images of plural colors on a single image holding member.

In the above-described explanation, the multifunction device is illustrated as an instance of the image forming apparatus. However, the image forming apparatus of the invention may be a monochrome dedicated device, or a facsimile, a copier, or a color printer.

In the above-described explanation, the image forming apparatus of the indirect transfer method using the intermediate transfer belt is illustrated as an instance the image forming apparatus. However, the image forming apparatus may be an image forming apparatus of a direct transfer method which directly transfers a toner image from the image forming unit to sheet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An antitheft apparatus comprising:
an approach detector that is disposed on an apparatus where consumables are mounted, and detects a person who approaches the apparatus;
a recording unit that records a captured image of the person when the person's approaching is detected by the approach detector; and
a removal detector that detects that the consumables are removed from the apparatus,
wherein, when the removal of the consumables is detected by the removal detector, the recording unit matches an image which is captured by a capturing apparatus at a most recent time before the detecting of the removal of the consumables, with information of the detecting of the removal of the consumables, and records the image and the information.

2. The antitheft apparatus of claim 1, further comprising a notification unit that notifies the information recorded on the recording unit in a predetermined notification method.

3. An image forming apparatus comprising:
an image forming unit that forms an image on recording material;
a consumables mounting unit that has consumables mounted therein, the consumables being consumed in the image forming unit;
a removal detector that detects that the consumables are removed from the consumables mounting unit;
an approach detector that detects a person approaching the image forming apparatus; and
a recording unit that records a captured image of the person when the person's approaching is detected by the approach detector,
wherein, when the removal of the consumables detected by the removal detector, the recording unit matches an image which is photographed by a photographer at a most recent time before the detecting of the removal of the consumables, with information of the detecting of the removal of the consumables, and records the image and the information.

4. The image forming apparatus of claim 3, wherein the consumables include a drum cartridge, and the removal detector detects a removal of the drum cartridge.

5. The image forming apparatus of claim 3, wherein the consumables include the recording material, and the removal detector detects a removal of the recording material.
